(19) United States
(12) Patent Application Publication
(10) Pub. No.: US 2013/0048642 A1
(43) Pub. Date: Feb. 28, 2013

(54) SUPPORTS FOR TANKS

(71) Applicants: Arne Barrett Sele, Hosle (NO); Trygve Johannes Lund, Oslo (NO)

(72) Inventors: Arne Barrett Sele, Hosle (NO); Trygve Johannes Lund, Oslo (NO)

(73) Assignee: Aker Engineering & Technology AS, Lysaker (NO)

(21) Appl. No.: 13/505,276

(22) PCT Filed: Oct. 29, 2010
(86) PCT No.: PCT/NO10/00391

§ 371 Date: Sep. 19, 2012

(30) Foreign Application Priority Data
Oct. 29, 2009 (NO) 20093245
Jul. 2, 2010 (NO) 20100970

(51) Int. Cl. F17C 13/00; F17C 3/00

(52) U.S. Cl. 220/562

(57) ABSTRACT

A support assembly mounted on the roof of a tank, comprising a support block (1), a base plate (4) between the support block (1) and the tank, and guiding brackets or rails (2) joined to a structure above the tank characterized in that each of the brackets or rails (2) comprise a face turned towards a cooperating face of the support block, the face of the bracket or rail and the cooperating face of the support block (1) are inclined at an angle, said angle depending on the width and height of the support (1).

### FIELD OF INVENTION

The present invention relates to tanks for storage and transportation of fluids such as hydrocarbons, including low temperature liquefied natural gas. This includes tanks for ships and floating offshore structures exposed to wave loads as well as gravity based offshore structures and land tanks exposed to earthquakes.

### BACKGROUND OF THE INVENTION

Supports on the roof of tanks restrain the structure at roof level to limit the loads experienced by the tank due to heeling, pitching or collision and in the case of tanks supported on a rigid base the effect of earthquakes.

Such tanks may be supported by timber supports of various types or supports of similar materials. The present technology for anchoring such supports to the top of the tank is to weld on vertical guide rails or brackets and similar rails or brackets on the roof of the hull. These brackets principally restrain transverse shear load and allow the tank to contract thermally while maintaining parallel supports by the rails.

U.S. Pat. No. 5,531,178 A discloses supports on the roof of tanks. The supports are anchored to the top of the tank by welding.

### OBJECT OF THE INVENTION

The object of the present invention is to provide a support which is prevented from overturning, and thereby making it possible for said support to be mounted on the roof of a tank without the use of potentially fatigue inducing welding on the top of said tank.

### SUMMARY OF THE INVENTION

The object of the present invention is obtained by anchoring the supports into moderately inclined welded rails or brackets. By providing brackets with a suitable inclination and a support with a suitable width the centre of the compressive force will fall within the base of the support preventing uplift and overturning of the support block. This arrangement allows the transverse load due to sea motion to be anchored in a rib and by direct compression on the tank.

For aluminium tanks exposed to fatigue it is desirable to anchor supports without welding. Welds may cause fatigue crack initiation which is a critical consideration for tanks containing liquefied gas. By anchoring the supports with for instance extruded ribs, the ribs being an integral part of the roof of the tank, fatigue of the tank is very significantly improved. Extruded ribs, or ribs formed by rolling, are base metal and are far better to resist fatigue and crack propagation than similar structures formed by welding to the tank. The supports are for instance placed in shallow welded boxes with a groove with which the rib, on the roof of the tank, mates. Fatigue cracks initiating in the support-box will not propagate into the tank and will not become a threat to safety.

The present invention is defined by:

A support assembly mounted on the roof of a tank, comprising a support block , a base plate between the support block and the tank, and guiding brackets or rails joined to a structure above the tank, characterized in that each of the brackets or rails comprise a face turned towards a cooperating face of the support block, the face of the bracket or rail and the cooperating face of the support block are inclined at an angle, said angle depending on the width and height of the support.

In a preferred embodiment of the support assembly, the faces of the rails or brackets turned towards the support block, and the corresponding faces on said support block, are leaning towards the uppermost centre of said support block, to the same degree with respect to the vertical.

In one embodiment of the support assembly, the base plate of the support block is secured to the roof of the tank by a rib.

In one embodiment of the support assembly the rib is an integral part of the roof of the tank.

In one embodiment of the support assembly, the rib is formed by extrusion or rolling.

In one embodiment of the support assembly, the base plate comprises ribs attached at each end of said plate.

In one embodiment of the support assembly, the base plate comprises a groove on the side facing the tank. The groove is dimensioned to accommodate a rib on the roof of the tank.

In preferred embodiments of the support assembly, the inclination angle is within the range of 8-25°, preferably within 10-20° and more preferably within 12-17°.

In preferred embodiments of the support assembly, the ratio of the width to the height of the support is within the range of 2.0-5.0, preferably within the range of about 2.5 to about 4.5, and more preferably within the range of about 3 to about 4.

### BRIEF DESCRIPTION OF THE DRAWING

Further details of the invention will be described below with reference to the exemplifying embodiments shown schematically in the appended drawings, wherein:

FIG. 1 shows a cross section of a support assembly with an inclined face.

FIG. 2 shows a longitudinal section of a gas carrier with internal tanks.

FIG. 3 shows a transverse section of a gas carrier with internal tanks.

### DETAILED DESCRIPTION OF THE DRAWING

FIG. 1 shows a cross section of the support assembly. The support block 1 is made from timber or other suitable material. The timber support block is constrained by inclined guiding brackets or rails 2 welded to the hull. It is also constrained by a base plate 4 with ribs 6 attached at each end of the base plate 4. The base plate is welded to a narrow rail 7 which accommodates an extruded rib 5 which is part of an extruded beam element from which the tank is fabricated. Due to the low temperature of the cargo tank when in operation, the tank will contract causing a modest gap 3 to develop between the inclined guides 2 and the inclined face of the support 1. By making the support wide, the angle of inclination will be limited, and so will the gap.

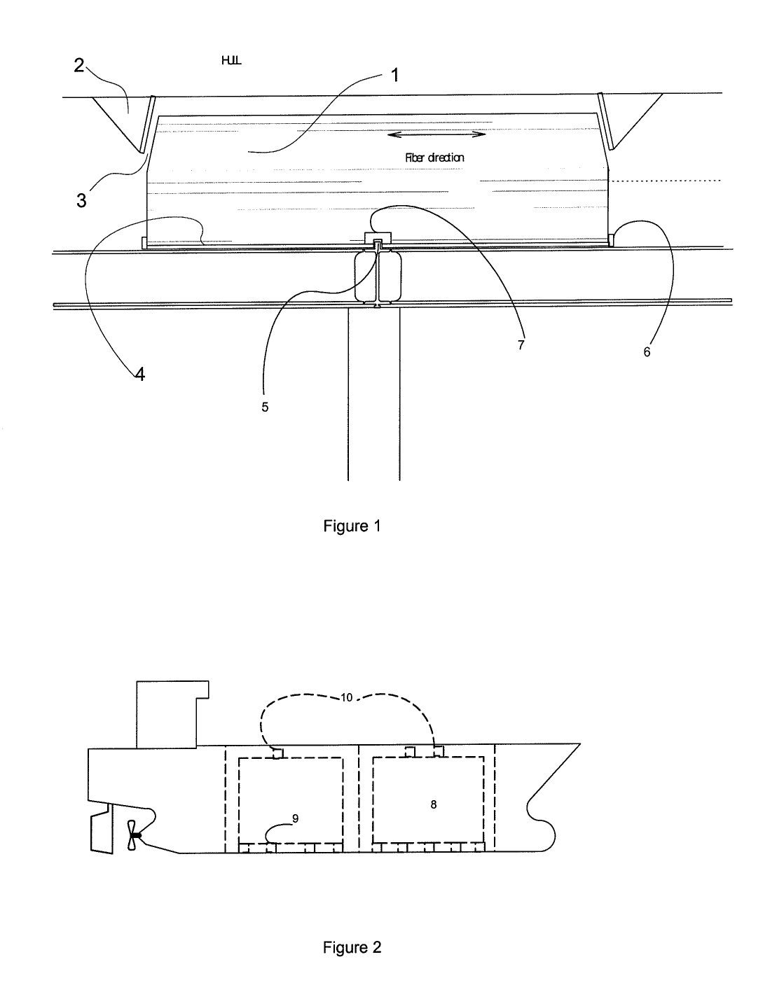

FIG. 2 shows a longitudinal section of a gas carrier with internal tanks 8, bottom supports 9 and supports above the tank roof 10.

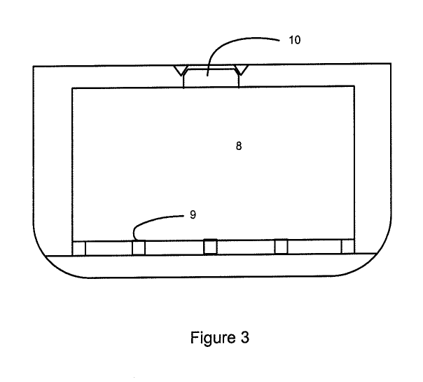

FIG. 3 shows a transverse section of a gas carrier with internal tanks 8, bottom supports 9 and supports above the tank roof 10.

1. A tank comprising a support assembly mounted on the roof of said tank, the support assembly comprising a support block and guiding brackets or rails joined to a structure above the tank, each of the brackets or rails comprise a face turned towards a cooperating face of the support block, wherein the face of the bracket or rail and the cooperating face of the support block are inclined at a substantially similar angle based on the width and height of the support, and wherein the support assembly has a base plate between the support block and the tank, said base plate being secured to the roof of the tank by a rib which is an integral part of the roof of the tank and formed by extrusion or rolling.

2. (canceled)

3. (canceled)

4. (canceled)

5. The tank according to claim 1, wherein the base plate comprises ribs attached at each end of said plate.

6. The tank according to any of claim 1, wherein the base plate comprises a groove on the side facing the tank.

7. The tank according to claim 1, wherein the inclination angle is within the range of 8-25°.

8. The tank according to claim 1, wherein the ratio of the width to the height of the support block is within the range of 2.0-5.0.

9. The tank according to claim 1, wherein the faces of the rails or brackets turned towards the support block and the cooperating faces on said support block are leaning towards the uppermost centre of said support block to the same degree with respect to the vertical.
